(19) United States
(12) Patent Application Publication
(10) Pub. No.: US 2010/0164867 A1
(43) Pub. Date: Jul. 1, 2010

(54) MICROCONTROLLER HUMAN INTERFACE USING REMOTE PRINTF/SCANF

(76) Inventor: Gerald John (Jack) Lipovski, Austin, TX (US)

Correspondence Address: Gerald John (Jack) Lipovski, 15017 Calaveras Drive, Austin, TX, 78717, US

(21) Appl. No.: 12/721,676

(22) Filed: Mar. 11, 2010

Related U.S. Application Data
(63) Continuation-in-part of application No. 11/725,212, filed on Mar. 16, 2007.

(51) Int. Cl. G06F 3/02; G06F 3/033

(52) U.S. Cl. 345/160; 345/172

(57) ABSTRACT

A first microcontroller running an application with input-output is coupled through a serial communication channel to a second microcontroller running a human interface display and keyboard. The aforementioned first microcontroller sends a C-language printf( )-like format string and raw binary data variables to the aforementioned second microcontroller, which converts this data into ASCII character strings, which it displays. This second microcontroller, responsive to keyboard activity, edits the ASCII character strings, and sends updated raw binary data over the serial communication channel to the aforementioned first microcontroller, which rewrites this raw binary data in its memory. This apparatus reduces the size of the application's program memory. It puts such program memory removed from this first microcontroller into this second microcontroller, to reduce this first microcontroller's design and implementation cost, and implementing this second microcontroller using a flexible human interface program that can be reused without being reprogrammed.

### RELATED U.S. APPLICATION DATA

This application is a Continuation-in-part of co-pending application Ser. No. 11/725,212, Touch frame interface, filed Mar. 16, 2007, which is included herein by reference.

### BACKGROUND OF THE INVENTION

This invention is in the field of interfacing humans to electronic devices such as an application microcontroller (AMc). For instance an inexpensive microcontroller-based sweep signal generator was being designed to output a sequence of steps of audio sine waves, each step of which had a higher frequency. Such a generator requires a human interface to set the parameters such as the starting frequency, interval of time through which the frequency is constant, amplitude of the output waveform, and additional parameters. A conventional low-cost human interface would require a display and knobs on the sweep generator enclosure. A touch-screen display would be much more desirable, but would be much too costly. This application further uses floating point computation in the AMc to calculate raising-to-power, exponent and multiplication, so floating point data conversion is needed to prepare data that is to be shown on the display.

The inventor's ensuing analysis of human interface systems led to the development of a device that can display output and accept input very much like a touch-screen device, but at a much lower cost. It can be designed to be flexible so that it can be used with a wide range of small applications such as the aforementioned sweep signal generator, microcontroller-based NiCad battery chargers, microcontroller-based sprinkler systems, and so on, utilizing 5-volt or 3.3-volt supplies, sending data over a UART or IIC serial interface, at user-selectable baud rates, with various frame formats, and using various families of microcontrollers. Such a flexible human interface can be recovered from abandoned prototypes, stocked, and inserted in new systems. Thus reused, it will significantly reduce the new system's printed circuit board size, the new system's application's microcontroller's program memory size, and the new system designer's time-to-market and development cost. This application mainly concerns the data input and output software part of this device, and some aspects of its mechanical housing.

In this inventive system's classical prior art, a display is coupled to a microcontroller parallel port to implement 4-bit or 8-bit parallel communication, and a keyboard coupled to another microcontroller parallel port in which keyboard switches are configured in a 2-dimensional matrix, switches being coupled to rows and columns of this matrix of switches. ASCII character string data is sent to the display, and the keyboard is scanned to detect pressing of the keys. In this classical system, the application, display, and keyboard are coupled to and controlled from a single microcontroller, denoted AKDMc.

More recently, modules such as microEngineering Labs serial LCD board, have been and are being sold in which the display data is sent over a serial UART communication link, and Electronic Assembly Gmbh sells the 3-row 16 column Dog-me LCD board which can be connected via a 8-bit parallel, 4-bit parallel, and serial interfaces. These serial interfaces are easily coupled to serial I/O modules that are commonly available within most microcontrollers. But the data that is sent from the application to the display in either case remains encoded as an ASCII character string rather than as raw data. These prior art systems illustrate a progression of making the display and input subsystem more intelligent, and making the communications channel more adaptable as well as more standardized, to make them more flexible.

This application also builds upon John M. Baron's United States Patent Document 20020093492. Baron's system uses four switches disposed at the corners of a rectangular LCD. A user presses display edges to move the display's cursor and to change the values of variables that are displayed under the cursor. However, Baron's system is flawed in not accommodating lever action and noise, and requiring more costly precision machining This application's parent application resolves these problems, to provide sufficient capabilities to implement the key features of this application's art.

### SUMMARY OF THE INVENTION

A preferred embodiment of this invention uses a keyboard and LCD display as partially taught by Baron, coupled to a different keyboard-display microcontroller, KDMc, which is coupled to the aforementioned AMc that executes the application program. The AMc executes procedures, which are like the well-known printf( ) and scanf( ) procedures, to send a printf( )'s format character string and raw binary data to the KDMc, which displays the data, edits it, and then returns raw binary data back to AMc.

In this inventive system, raw binary data is sent from the processor AMc that controls the application to a keyboard-display processor KDMc that handles the display and keyboard. AMc's raw binary data declared to be types as C-language char, int, long, float, double, and character string data, is sent through the serial communications channel to KDMc, which internally converts this raw binary data to an ASCII character string, which is sent to the display and is thus displayed. For instance, if a 16-bit int variable at AMc location 0×102 is to be displayed in 4 digits or less, and has the numeric value 123, the raw data, binary number 0000000001111011, is read from AMc location 102 and sent from the AMc over the serial channel to the KDMc. The KDMc converts the raw binary data into the character string “<space>123”, where ASCII character <space> has hexadecimal value 0×20, and the other characters in the string are ‘1’ which has value 0×31, and ‘2’ which has value 0×32, and ‘3’ which has value 0×33. This ASCII character string is passed to the KDMc's display, which displays the ASCII characters “<space>123” in consecutive characters along a row of the display. This process is repeated for each data item that is to be displayed on the screen. Then the AMc waits for returned data.

This application's KDMc implements a simple screen-oriented character editor. Using the editor, a user can navigate a cursor to the character to be changed, and change the character pointed to by the cursor. For instance, the character ‘3’, discussed in the previous paragraph, can be changed to a ‘2’, by navigating the cursor to be over the character ‘3’ and then changing the character, that the cursor selects, from ‘3’ to ‘2’. The KDMc changes the aforementioned character string “<space>123” into string “<space>122”. When the user decides to resume the AMc's program, this KDMc converts the aforementioned character string into the raw-data binary number 0000000001111010, which is returned through the aforementioned serial communication channel to the AMc. The AMc stores the incoming int value in the location that it was taken from, location 0×102 in this example. When all data that was displayed on the screen has been returned to the AMc, the AMc resumes executing its program.

The KDMc can have software to convert data of any commonly used format into character strings to be sent to the display, and to reverse this process, to read characters that are being displayed, returning them to raw data. Surprisingly, such software is widely available and well-documented. In C-language compilers, such software is in the procedures printf( ) and scanf( ) and their cousins that are usually provided with that C compiler. However, these procedures can require huge amounts of memory. If printf( ) and scanf( ) are to handle float and double formats, as well as char, int, long, and character strings, this conversion software can require over 12 kBytes. If the KDMc doesn't handle the aforementioned data conversions, the AMc's program will require this software, as well as the application's software, and will thus not fit in least expensive microcontrollers that have only 4 kBytes to 8 kBytes of program memory. However, if the KDMc does handle the aforementioned conversions, the AMc's program will not require this software, but only the application's software, and thus may fit into least expensive microcontrollers that have only 4 kBytes to 8 kBytes of program memory. Although the KDMc program requires larger memory (16 kBytes), it is reusable and need not be rewritten after it is first written, to be put into a new application. That was the case in the sweep generator that was implemented; it put all printf( ) and related I/O code into the KDMc, fitting the rest of the application in 8 kBytes of AMc memory.

Additionally, in another preferred embodiment, the keyboard, LCD and microcontroller KDMc connected thereto can be replaced by a microcontroller CMc communicating via a personal computer PC's COM port. In this preferred embodiment, AMc's raw binary data is sent to CMc, where it is converted to character strings, is edited, the edited data is sent back as raw binary data from the CMc, all within the aforementioned CMc microcomputer, and the AMc writes the data in its memory. Meanwhile, ASCII characters are sent to the personal computer PC, to be displayed using a simple standard communications program like hyperterm, and PC keyboard human input is sent to CMc. This interface using CMc is an alternative to interfacing to a PC program which is passed raw binary data, using special procedures to display and edit the values of this aforementioned data. A PC program environment, comprising a compiler, linker, and window interface, is very different from the AMc environment. The application designer has to master this PC environment as well as the microcontroller environment in which the AMc is designed, raising the development cost, and increasing development time, compared to using CMc. Interfacing the AMc through a CMc eliminates the need to design and then run a special program on the PC to exactly match the AMc's program so that the program in the CMc and the program in the PC need not be modified to interface to any application.

The interface between the AMc and KDMc described above should be made identical to the interface between the AMc and CMc. This will facilitate reconnecting an AMc to either a KDMc or a CMc, or vice versa. The same AMc program can use either interface.

A first goal of this invention is to provide a low-cost flexible human interface for small applications. Another goal is to remove data conversion routines from the AMc, thereby requiring less program memory, which permits the use of a less-expensive AMc. A similar goal is to encourage the development of applications that use memory-intensive floating and double data formats, since when printf( ) code is moved from AMc memory to KDMc, they often fit in least expensive microcontrollers. Another goal is to utilize a PC running a character display like hyperterm to replace the 4-key keyboard and LCD display described above, so that the PC uses the same interface as the LCD, to use either interface and easily switch between them. And another goal of this invention is to use well-known formats, especially the printf( ) format, to define what conversions will be done in the KDMc. Using a well-known format should lead to rapid adoption of the system.

### BRIEF DESCRIPTION OF THE DRAWINGS

The novel features of the invention are described with particularity in the claims. The invention, together with its objects and advantages, will be better understood after referring to the following description and the accompanying figures, in which common numerals are intended to refer to common elements.

FIG. 1 is a block diagram of an application microcontroller coupled to a human interface system.

FIG. 2 is a call to printf( ) to print character string, decimal, and floating point data.

FIG. 3 shows a C macro va( ) that is used in FIG. 4.

FIG. 4 shows a call to reScan( ) that replaces the call to printf( ) in FIG. 2.

FIG. 5 shows a simple main( ) procedure calling reScan( ) and waitForData( ).

FIG. 6 is a listing of C procedure reScan( ).

FIG. 7 is a listing of C procedure waitForData( ).

FIG. 8 is a drawing of enclosure boxes and switch positions.

FIG. 9 is a drawing showing the relationship between the display and zones.

FIG. 10 is a block diagram of a related system that uses a personal computer.

### DETAILED DESCRIPTION OF THE PREFERRED EMBODIMENT

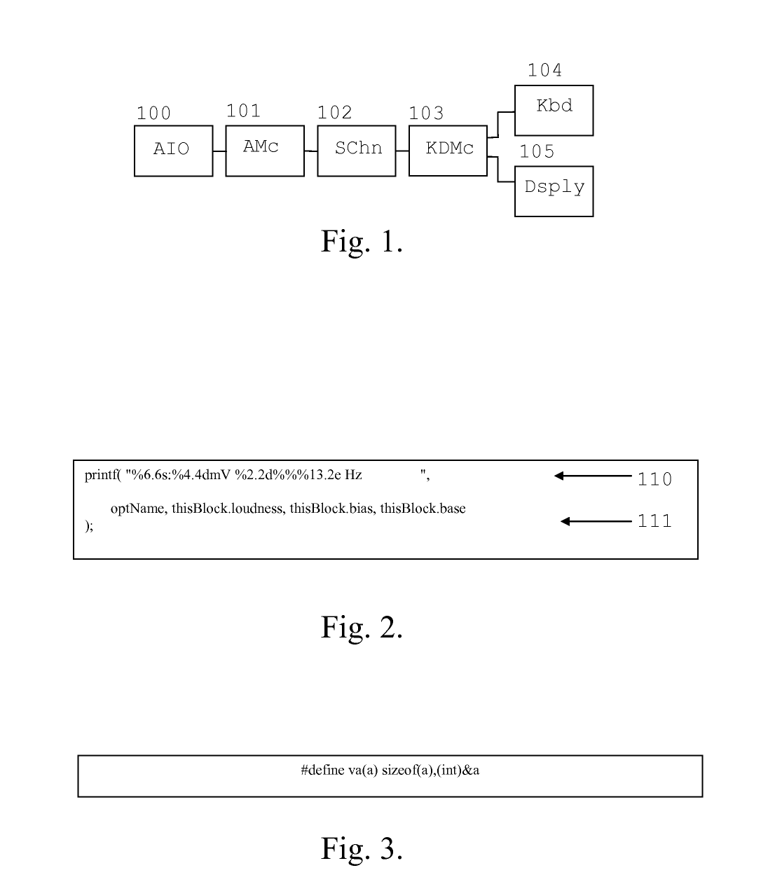

FIG. 1 illustrates a typical system incorporating a human interface according to this invention. An application, such as a system measuring a voltage, will have application I/O 100 such as a D-to-A converter coupled to an application microcontroller (AMc) 101 whose program controls application I/O 100. This microcontroller is coupled through serial I/O channel 102 to a keyboard-display microcontroller (KDMc) 103. In this preferred embodiment, this channel is a Universal Receiver-Transmitter (UART) device, but can also be an Inter-Integrated Circuit Standard (IIC) device, or a parallel port. KDMc is coupled to keyboard 104 and display 105. The following discussion shows the components and the steps, used to respond to a procedure call statement in AMc 101's program, which displays some data and replaces this data in AMc 101's memory.

Application microcontroller 101's program comprises serial I/O device driver, through which it communicates through SChn 102 to KDMc 103, a procedure to gather data that needs to be displayed, and a procedure that rewrites data in AMc's memory that might be changed by an editor in the KDMc. A call is made to both aforementioned procedures for each AMc program step that outputs data to the KDMc to be displayed, and then inputs data that may have been changed by the KDMc, into AMc's memory.

This inventive system is comprised of a KDMc 103 that is directly coupled to a character or graphical display 105 having a cursor, to momentary contact switches 104 which are disposed at the display's corners and, through a serial communication channel SChn 102, to the aforementioned AMc 101. Using these components, the display microcontroller incorporates formatting software to encode output essentially using printf( ) reverse-formatting software to decode input essentially using scanf( ), and touch-frame monitoring of the aforementioned switches to navigate the display cursor and edit display data. Packaging the display microcontroller, display, switches, and one end of the serial communication channel into a module which performs formatting, that module can be quickly and effortlessly attached to a developing system, the AMc can be small, both in printed circuit board area and program memory capacity, and quickly programmed because much common code is removed to KDMc, essentially being never changed there.

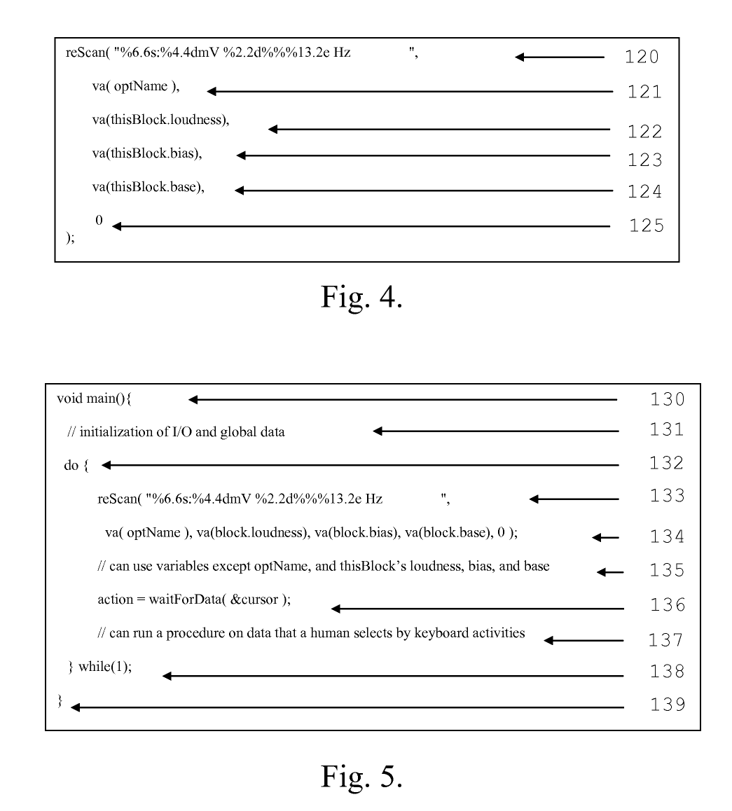

When AMc 101's program needs to send data to the display and return data from the display and keyboard, it first calls a C procedure reScan( ) such as the statement that is shown in FIG. 4. This call to reScan( ) is very similar to printf( ) shown in FIG. 2, whose components are now discussed; these shall be related to similar components of reScan( ). The syntax of calling printf( ) is well-known to persons of ordinary skill in the art of programming application microcontrollers. Recall that printf( )'s first argument on line 110 is called the format string; it defines the format for each of the data variables in line 111; this example's first format entry, % 6.6s, shows that the first data variable optName is exactly a six-character ASCII string. Its second format entry, % 4.4d, shows that the second data variable, thisBlock.loudness, is exactly a 4-character decimal number. Its third format entry, % 2.2d, shows that the third data variable, thisBlock.bias, is exactly a 2-character decimal number. Its last format entry, % 13.2e, shows that the fourth data variable, thisBlock.base, is a 13-character floating point decimal number, having a two-character fraction.

reScan's arguments, shown in FIG. 4, are essentially identical to printf( )'s arguments shown in FIG. 2, except for the following differences. reScan( )'s format string on line 120 is identical to printf( )'s format string, but usually in both format strings, each data variable's format in calls should be exactly specified, being limited both for maximum and minimum widths; i.e. use fixed-width format % 6.6s rather than variable-width format % s. Each data variable, on lines 121, 122, 123, and 124, needs to use the macro shown in FIG. 3 to pass the data variable's location and its width; i.e. use va(optName) rather than optName. It passes sizeof(optName) and (int)&optName to rescan( ). Finally, an extra parameter 125, whose value is 0, needs to be appended to the argument list to terminate the list. Since these changes are very modest, reScan( )'s arguments are claimed to be essentially identical to printf( )'s arguments.

Additional data types, which are not used in printf( ) procedures, may be added in KDMC's program. For example, a second-of-week data type would allow raw data representing the number of seconds since Sunday 12:00 A.M., to be viewed and edited as a four field data variable DD:HH:MM:SS, where DD is the day-of-week, HH is the (military time) hour in the day, and so on. And some data types available in printf( ) may not be useful in reScan( ), so they may be omitted.

FIG. 5 illustrates a main( ) procedure 130 that calls reScan( ) 133 and waitForData( ) 136, in an infinite loop. This main( ) procedure contains typical code to support repetitive calls to these procedures. All I/O devices and global data are initialized before the loop is entered, as suggested by line 131, The do while loop begins on line 132 and ends on line 138. Each time though the loop it calls reScan( ) (133 and 134) to let the user select the desired application and supply it with data. While the KDMc is interacting with the user, the AMc can read or write data, provided that this data is not listed in reScan( )'s argument list, as suggested by line 135. Often there is no such data, and reScan( ) is immediately followed by waitForData( ). While the AMc is executing waitForData( ), KDMc may change the data as a result of keyboard activities. Generally, the human user's selection and data, returned by waitForData( ), is used in the statements and procedures indicated by line 137. waitForData( ) also returns the location of the display cursor when KDMc stopped running, reasons for ending the display, and errors encountered with changing data or communicating through the serial channel 102. The AMc's program can react to waitForData( )'s returned information by executing various AMc's procedures, until they are terminated by executing a next call to reScan( ) in the infinite loop.

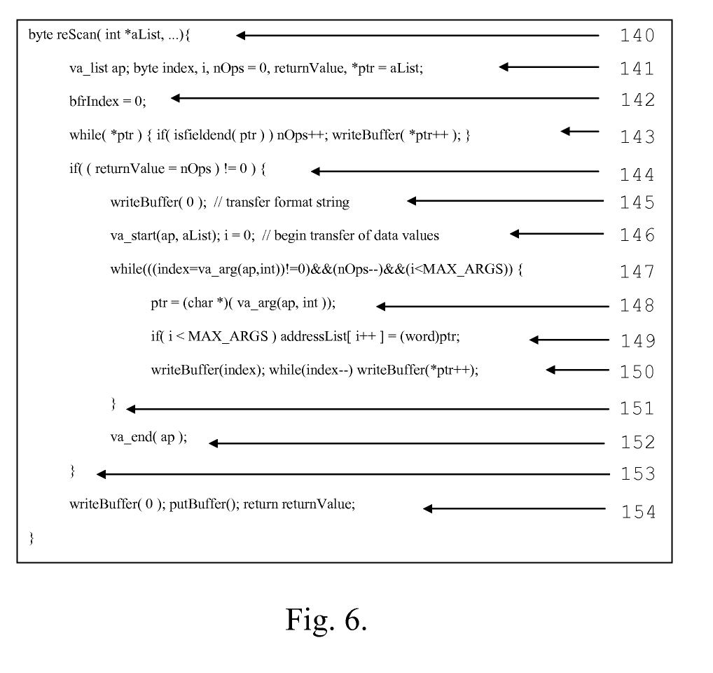

reScan( ) is listed in FIG. 6. reScan( )'s first argument int *aList on line 140 passes the address of reScan( )'s format string. In line 141 this address is copied into ptr, which is used in line 143 to transfer all format characters into procedure writeBuffer( ), from whence they will be sent through the communication channel 102. While transferring the format characters, this procedure obtains a count nOps of the number of data operands that are expected. (The procedure isfieldend( ) returns a 1 if the character being moved is the end of a data value's field.)

reScan( )'s second argument on line 140, an ellipsis . . . , represents an arbitrarily long list of data variables that are shown together on the display. The C compiler variables and macros va_list, va_start( ) va_arg( ) and va_end are specifically implemented in the C compiler to handle variable-length argument lists, which are specifically needed to implement the widely used C procedure printf( ). They are useful in gathering the data from the AMc that needs to be sent to the KDMc in this inventive system.

If the number of data variables is zero, tested in line 144, the format string is displayed as it appears in this string in line 120. This can be used, for instance, to display help or error messages. Otherwise the null character is output to terminate the format string by writeBuffer( ) in line 145. Then the variable-length argument list is prepared for use in line 146 and the while loop 147 to 151 is executed, once for each data variable in the format string. Recall the use of a macro va( ) to pass each data variable's size and address. This size is read at the beginning of line 147, and its location is read in line 148. This address is saved in a vector addressList 149, to be used by the waitForData( ) procedure line 168. Then, on line 154, the data collected by procedure writeBuffer( ) is passed, by executing procedure putBuffer( ), through the serial communication channel 102 to KBMc. Note that, provided with the name of a data variable, the macro va( ) passes its size and address; it does so to provide for the two inputs needed by the waitForData( ) while loop. Note that the while loop is executed until a ‘0’ argument is passed for the size of the data variable; that is why the ‘0’, shown in line 125, is appended by procedure writeBuffer( ) in line 154.

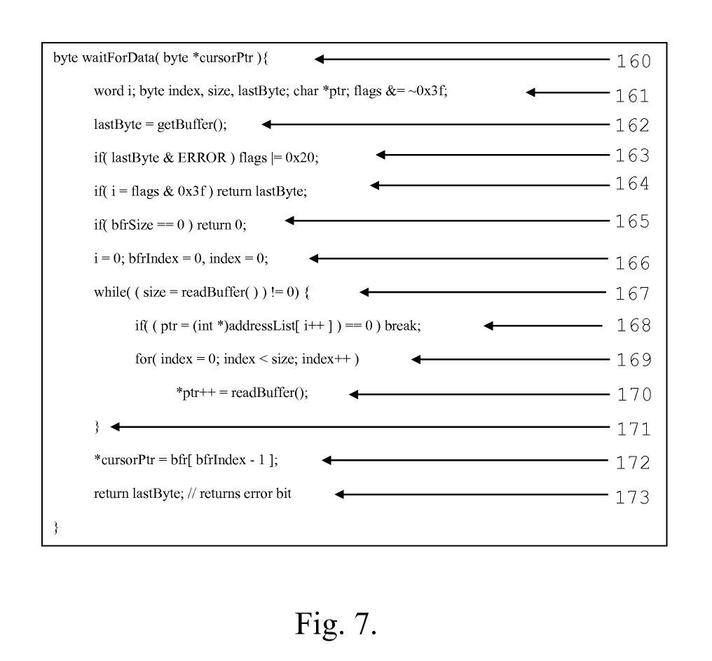

The waitForData( ) procedure 160 is listed in FIG. 7. The least significant bits of global variable flags are initially cleared in line 161, being then set in interrupt handlers if a communication error occurs, or in queue push instructions if there is a queue overflow error. waitForData( ) waits in getBuffer( ) called from line 162 until all data has been transferred. The last byte that was sent comprises aggregate error status returned from KDMc, which is put in lastByte. If there were errors, waitForData( ) exits on line 164. If no data is transferred, waitForData( ) exits on line 165. Note that if errors have occurred, the returned data is not written into AMc memory. A loop, from line 167 to 171, is initialized in line 166. The size of the data is read in line 167, and “size” bytes of data are read in lines 169 to 170. The data read are written into AMc's memory using the address passed in addressList 168. Note that the address of the data variables are not passed to KDMc through serial communications channel 102 because the human interface system in KDMc does not need to know where they are located in AMc. The addresses are kept as a global variable vector AddressList that was written in reScan( ). After all data variables are read, the value of the current location of the display cursor is written in line 172. The aggregate error information is returned to the caller in line 173.

In KDMc, all raw binary data arriving in the serial I/O channel 102 is written in comBuffer, essentially duplicating the data variables that will be displayed from AMc into KDMc. The bytes in comBuffer are passed to an actual printf( )-like procedure which generates an ASCII character string sent to scrnBuffer, which is sent to the display 105. When that is completed, KDMc senses the switches in Kbd 104 to modify data being displayed in 105, essentially operating as a simple character-oriented screen editor. All this editor's changes that are made, responsive to keyboard inputs, are made to the ASCII characters stored in scrnBuffer, and after each such change, data in scrnBuffer are sent to the display 105.

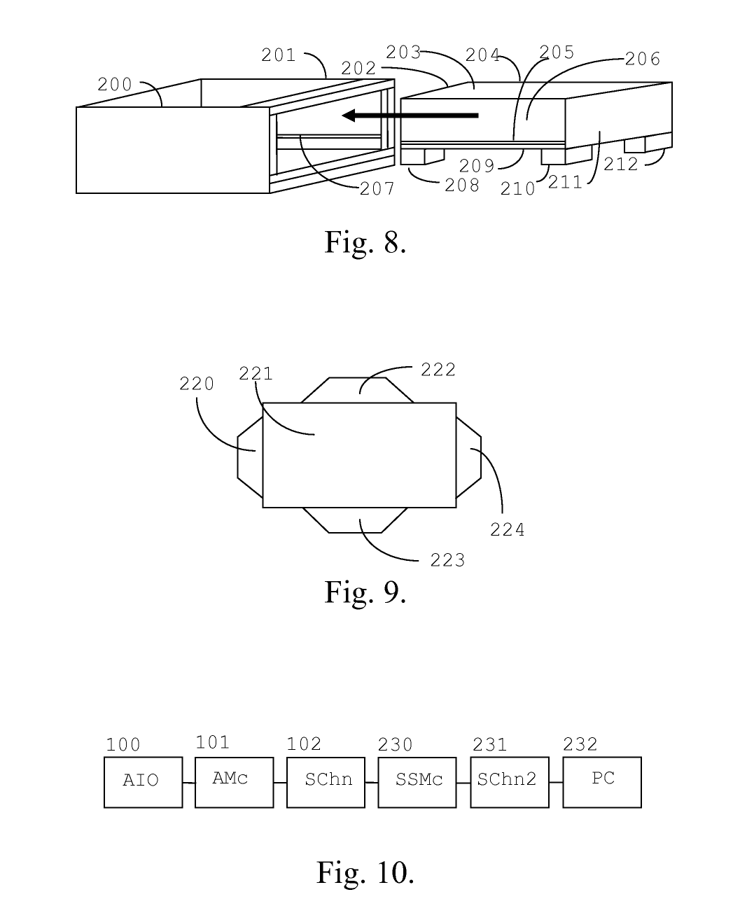

The keys, display, and printed circuit board connected to KDMc, are drawn in FIG. 8. A rectangular LCD is positioned on the top surface 203, and a printed circuit board, connected to the KDMc, is disposed on the bottom surface 209 of an inner box, whose other surfaces are 202, 204, 211 and 206. Keyboard switches 208, 210, 212 and a fourth keyboard switch that is hidden by front surface 206, are disposed at each corner of this printed circuit board. A horizontal ridge 205 is connected to surface 206, and another such horizontal ridge is connected in like manner to surface 204, but this ridge is not shown because it is hidden behind other surfaces 206, 211 and 204.

An outer box is comprised of surfaces 200, 201, and similar back and bottom surfaces that are not visible in this drawing, but this outer box's top and right surfaces are open. The inner box described above is inserted into the outer box through the outer box's open right surface. A horizontal ridge 207 is connected to back surface 201, and another such ridge is connected in like manner to surface 200, but this ridge is not shown because it is hidden behind this surface.

The aforementioned ridges are adjusted so that when no pressure is applied, the inner box's ridges are just below the outer box's ridges, to prevent the inner box from falling through the absent top surface of the outer box. The human user can apply finger pressure to the inner box 203's top surface to cause the switches to be closed, as described below.

FIG. 9 illustrates the top surface 203 of the inner box supporting the LCD display 221. This figure shows zones, left 220, top 222, bottom 223 and right 224, where pressure can be applied to the top surface of the inner box. Pressing any one zone, the ridge nearest the zone opposite to this zone being held down by the outer box's ridge and serving as a hinge, closes the two switches nearest the zone that was pressed through a lever action. For instance, if bottom zone 223 is pressed, the outer box's top ridge 207 holds down the inner box's top ridge (not shown) to effect a hinge, so switches 208 and 210 are closed. Additionally, pressure can also be applied simultaneously to any two zones, to cause three or more switches to close. Pressure applied to these zones reliably causes switches at the rectangle's corners on both sides of the zone to be closed. Pressure outside these zones, in the LCD display or near the corners, can cause ambiguous results due to noise, lever action or races. The software monitoring the keyboard should ignore noise and the human user should not press down on the top surface outside the zones.

A predetermined threshold time, such as two seconds, differentiates between a click, which is: pressing and releasing for a time less than this threshold, and a controlled race, which is: pressing and holding down the switch for a time greater than this threshold. The display has a cursor to identify a display character to be operated on. Clicking navigates the cursor, but does not move it if this would cause the cursor to move out of the display screen. Clicking the left zone causes the aforementioned cursor to move one character position towards the left; clicking the top zone causes the aforementioned cursor to move one character position towards the top; clicking the bottom zone causes the aforementioned cursor to move one character position towards the bottom; and clicking the right zone causes the aforementioned cursor to move one character position towards the right.

A controlled race, pressing and holding the left zone 220 moves the cursor left at a rate of, say, two character positions each second, and a controlled race, pressing and holding the right zone 224 moves the cursor right at a rate of two character positions each second. This permits the cursor to be rapidly moved on the same horizontal line.

A controlled race, pressing the top zone 222 increments the value of the character that the cursor identifies at a rate of two values each second, and pressing the bottom zone 223 decrements the value of the character that the cursor identifies at a rate of two values each second. This permits a number like 0 to be changed to 5 just by pressing on the top zone 222 and holding it down for 2+2.5 seconds rather than clicking the zone five times. (The first 2 seconds accounts for the aforementioned delay due to the threshold time.)

Finally, clicking on any two zones at the same time will suspend the screen editor's routine in KDMc, return all data variables to AMc and resume the AMc's program. When the aforementioned clicking takes place, a scanf( )-like procedure is executed in KDMc to read the character string data in dsplBuffer to rewrite the raw binary data in comBuffer, reflecting all changes to the data variables that have been caused by editing the former.

This inventive system takes advantage of the printf( ) format string, passed to KDMc, to make the screen editor more intelligent. When a character is to be incremented or decremented, the format string is examined to determine how to terminate the incrementing or decrementing operation. For instance, if the cursor is over an octal data field (format specifier % o) and the digit under the cursor is less than 7, the digit is incremented; otherwise it is not changed. If the cursor is over a hexadecimal field (format specifier % x) and the digit under the cursor is less than 0xf, the digit is incremented; otherwise it is not changed. Otherwise if the cursor is over any numeric field and the digit under the cursor is less than 9, the digit is incremented; otherwise it is not changed.

Furthermore, if the cursor is over a character string that is to be “incremented”, the KDMc sends the cursor position to the AMc to update the whole character string. For instance, if the character string is the dayOfTheWeek, and has the value “Wed”, and the KDMc is trying to increment it due to pressing and holding down the top zone 222 for just more than the aforementioned threshold, 2 seconds, then the string “Thu” is sent from the AMc to the KDMc to display it. The AMc contains, selects and sends all such variable character string (format specifier % 4.4s) to the KDMc, rather than storing such strings in the KDMc, because the KDMc is not supposed to be changed when it is used in a new system, while AMc is flexibly application-related and is expected to be changed for each application. There are several ways for the KDMc to make the AMc send this character string, such as “Thu”, from the AMC back to the KDMc.

It is possible to also implement a “double-click”, wherein a zone is pressed twice within the time that a single click would normally be allowed to take, to differentiate it from a controlled race or a single click. It would function in a similar manner to how Windows uses a mouse's double-click. However, this preferred embodiment does not need any additional keyboard operations, so double-clicking is not used.

Additionally, the keyboard, LCD and microcontroller connected thereto can be replaced by a microcontroller CMc communicating via a COM port to a personal computer that is executing a hyperterm, or equivalent, character-oriented screen editor. FIG. 10 is a diagram of a related system that uses a personal computer rather than a keyboard and LCD display. The application I/O 100, application microcontroller 101, and serial communication channel 102 are identical in both FIGS. 1 and 10. This related system replaces FIG. 1's KDMc 103, keyboard 104, and display 105, with serial-to-serial microcontroller SSMc 230, second serial communication channel SChn2 231, and personal computer PC 232. In this preferred embodiment, this channel 231 is an RS232 communication channel (which is like the UART protocol but uses higher voltages), but it may also be a Universal Serial Bus (USB) or an Ethernet device. The operation of the application-related components, 100, 101, and 102, is the same in the related system as in the original embodiment, from the AMc executing a reScan( ) to its completing the waitForData( ) procedure. But in this related system, when a character string is put into the scrnBuffer, the contents of scrnBuffer are sent though SChn2 231, which can be an RS232 PC COM port, which is passed to a hyperterm program, which displays the characters sent to it on the PC 232 screen. Keys on the PC keyboard can be used to mimic the four keys that the original system had positioned under the display. Based on the key values sent from the PC 232 to the SSMc 230 over second serial communications channel SSCH2 231, modifications can be made to the scrnBuffer. When this is done, the character string can be sent through second communication channel SSChn 231 to the PC executing hyperterm.

This alternative embodiment for controlling the AMc eliminates the need to design and then run a special program on the personal computer to match each AMc's program. This alternative embodiment would be useful to facilitate reconnecting an AMc to either a keyboard-display microcontroller or a microcontroller communicating via a COM port to a personal computer, without altering the AMc's program.

Using hyperterm, data from AMc executing a reScan( ), or data resulting from an editing operation, can be put on a line of the screen such that each screen line represents the data variables in consecutive data entry or edit operations. A carriage return with a line feed can precede each line to provide a history of each of the changes made to the contents of scrnBuffer, on each consecutive display line. Alternatively, a carriage return without a line feed can precede each line, so the data is rewritten on the same screen line.

Another extension related to this inventive system stores the format strings in KDMc nonvolatile memory, sending some identifier with the data variables from AMc to KDMc. Upon receipt of data to be displayed, that identifier would be used to set a pointer to the format string. That identifier might be an index used to choose the pointer, or it might be implied, as each successive arrival of data increments that index. For instance, if the character string is the dayOfTheWeek, and is currently “Wed”, and the KDMc is trying to increment it due to pressing and holding down the top zone for just more than the aforementioned threshold, 2 seconds, and if the new string “Thu” is the fifth string, the index 5 is sent though the display from the AMc to the KDMc to display it, and the latter KDMc uses index 5 to output its fifth string “Thu”. While this extension generally requires less time to send the index rather than to send the string, the KDMc's program is no longer able to be programmed just once, never to be reprogrammed a second time.

A final extension to the second embodiment is to write a program that does what the program does in DKMc, in a PC program. However, this program would require that raw binary data, not ASCII character string data, pass between the AMc and PC. It is possible to accidentally send raw binary data that happens to be a control code in the communications software that causes undesirable actions therein, so this extension is not as attractive as the first preferred embodiment.

To summarize, this invention provides a low-cost flexible human interface for small applications. Data conversion routines from the AMc are removed from the AMc, thereby requiring less program memory in the AMc, which permits the use of a less-expensive AMc. The inventive system encourages the use of floating point and double data formats in small and inexpensive AMc's. This invention uses well-known formats such as the printf( ) format, to define what conversions will be done in the KDMc. Finally, a similar system that replaces the KDMc, keyboard and display, with a communication channel coupled to a personal computer, permits replacing the KDMc, keyboard, and display with a microcontroller coupled through a serial communication channel to a personal computer running hyperterm. This permits changing from an LCD-keyboard implementation to a PC implementation with ease, allowing the human user to select the better alternative for the human interface portion of the program, or switch to the other alternative with ease.

Modifications to this invention can be made by one skilled in the art without departing from the spirit of the invention. While the invention has been described in connection with an illustrative embodiment, obvious variations therein will be apparent to those skilled in the art without the exercise of invention, accordingly the invention should be limited only to the scope of the appended claims.

I claim:

1. An apparatus consisting of:
a) a first microcontroller, and associated input-output coupled to it to run an application,
b) a second microcontroller, and associated character display output and associated keyboard-operated human user input to interface to a human operator,
c) said first and second microcontrollers coupled to each other though a first serial communication channel,
d) such that said first microcontroller sends a format string and raw binary data variables over said first serial communication channel to said second microcontroller,
e) such that while said first microcontroller waits, said second microcontroller:
i) uses said format string to convert said raw binary data into ASCII character strings representing said data's values,
ii) displays said ASCII character strings on a display screen,
iii) monitors a keyboard, whose keys are able to be closed by human action, from which said actions provide display-oriented commands to navigate a cursor,
iv) monitors said keyboard to change characters in said ASCII character strings,
v) translates said strings into raw binary data represented by said strings,
vi) sends said raw binary data over said first communication channel to first microcontroller,
e) and such that said first microcontroller receives said raw binary data and rewrites possibly modified raw binary data in its memory.

2. An apparatus according to claim 1 in which said display and keyboard apparatus coupled to said second microcontroller is an LCD display in which said keyboard switches are disposed in proximity to corners of said LCD display.

3. An apparatus according to claim 1 in which said display and keyboard apparatus is a personal computer's display and keyboard, and said personal computer runs a simple communications program, and in which said personal computing is coupled through a second serial communication channel, to send ASCII character strings to or from said second microcontroller from or to said personal computer.

4. An apparatus according to claim 1 in which said first serial communication channel is a Universal Asynchronous Receiver-Transmitter (UART) serial channel.

5. An apparatus according to claim 1 in which said first serial communication channel is an Inter-Integrated Circuit Standard (IIC) serial channel.

6. An apparatus according to claim 3 in which said second serial communication channel is an RS232 communication channel.

7. An apparatus according to claim 3 in which said second serial communication channel is a USB channel.

8. An apparatus according to claim 3 in which said second serial communication channel is an Ethernet channel.

9. An apparatus comprising of:
a) an electronic device,
b) a convex polygon-shaped two-dimensional display used to output information from said electronic device to a human user,
c) a plurality of switches used to input information from said human user to said device, each switch being disposed near each corner of said display,
d) such that when a zone adjacent to a convex polygonal display is pressed and held down, two switches are closed, causing an operation to be repeated, in said electronic device or in said display, at a predetermined rate of speed as long as said zone is pressed and held down.

10. An apparatus according to claim 9 in which said repeated operation is moving a cursor as long as said side is pressed and held down, and the cursor does not disappear off the display screen.

11. An apparatus according to claim 9 in which said repeated operation increments or decrements the value of a character that is selected by the cursor, as long as said character remains within the range of permissible values of said character.

12. A method of a human controlling an application microcontroller, comprising:
a) compiling a first and a second procedure, to be executed in a first microcontroller that implements an application and is coupled to application's input-output, said compilation comprising:
i) compiling a call to said first procedure to accept a first argument to pass a format string, which is essentially a printf( ) format string, and to possibly accept a second argument to pass raw binary data, said format string describing the data-type format for any said data variable passed as a second argument,
ii) compiling a call to said second procedure to wait for raw binary data to be returned from a second microcontroller, and to replace said raw data in said first microcontroller's memory with associated data received from said second microcontroller,
b) executing said first procedure in said first microcontroller to output said format string and said raw binary data through a first serial communication channel to said second microcontroller,
c) executing said second procedure in said first microcontroller, which waits for data from said second microcontroller,
d) waiting concurrently in said first microcontroller for said data, said second microcontroller executing:
i) converting said raw binary data into ASCII character strings representing the values of said data variables,
ii) sending said ASCII character strings to a display,
iii) editing said displayed character strings to change characters therein as a result of keyboard actions by a human user,
iv) converting said edited character strings to raw binary data,
v) sending said raw binary data through said first serial communication channel,
e) executing said second procedure in said first microcontroller, rewriting said data variables in said first microcontroller memory, and resuming said first microcontroller's program that was waiting for data from said second microcontroller.

13. A method according to claim 12 in which said second microcontroller sends said ASCII character strings to an LCD display.

14. A method according to claim 12 in which said second microcontroller sends said ASCII character strings to a personal computer.

15. A method of claim 12 in which said first serial communication channel is a UART serial channel.

16. A method of claim 12 in which said first serial communication channel is an IIC serial channel.

17. A method of claim 13 in which said second serial communication channel is replaced with at least one parallel port.

18. A method of claim 14 in which said second serial communication channel is an RS232 serial channel.

19. A method of claim 14 in which said second serial communication channel is a USB channel.

20. A method of claim 14 in which said second serial communication channel is a Ethernet serial channel.
